(19) United States
(12) Patent Application Publication
(10) Pub. No.: US 2009/0089387 A1
(43) Pub. Date: Apr. 2, 2009

(54) ELECTRONIC MAIL COMMUNICATION APPARATUS

(75) Inventor: Chihiro HIRANO, Takahama-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/237,934

(22) Filed: Sep. 25, 2008

(30) Foreign Application Priority Data
Sep. 27, 2007 (JP) 2007-251131
Jun. 10, 2008 (JP) 2008-151698

(51) Int. Cl. G06F 15/16

(52) U.S. Cl. 709/206

(57) ABSTRACT

An electronic mail communication apparatus disclosed herein is connectable to a mail server and capable of transmitting electronic mail. The electronic mail communication apparatus includes; a connection test executing unit which conducts a detailed connection test necessary for establishing connection between the electronic mail communication apparatus and the mail server, in response to a first instruction; and a mail transmitting unit which conducts a simple connection test between the electronic mail communication apparatus and the mail server in response to a second instruction, and thereafter transmits electronic data as the electronic mail to the mail server when the simple connection test succeeds, wherein the simple connection test is simpler than the detailed connection test.

### CROSS REFERENCE TO RELATED APPLICATION

This application claims benefit of priority under 35 U.S.C. §119 to Japanese Patent Applications No. 2007-251131, filed on Sep. 27, 2007, and No. 2008-151698, filed on Jun. 10, 2008, the entire contents of which are incorporated by reference herein.

### BACKGROUND OF THE INVENTION

1. Field of the Invention

The present invention relates to an electronic mail communication apparatus, and particularly, to an electronic mail communication apparatus capable of transmitting electronic data as electronic mail.

2. Related Background Art

Some of so-called multifunction machines having a scanner function and a printer function has a function of making an image scanned by using the scanner function into a file and transmitting the image as electronic mail. The scanned image, when transmitted as electronic mail, is in a form of Tiff file or the like.

If the function of transmitting electronic mail, when used, is configured to establish the connection to the mail server after all the images have been read by using the scanner function, a failure in the connection between the multifunction machine and a mail server, if any, necessitates obtaining the images again for the purpose of the re-transmission. To avoid this problem, there has been known an art in which a multifunction machine sends connection request to a mail server before obtaining images by using the scanner function, and starts reading the images by using the scanner function after the connection is formally established (see, for example, Japanese Patent Application Laid-open No. 2000-324293).

In such a method, however, since all the procedures necessary for establishing the connection between the multifunction machine and the mail server are executed immediately before the start of the image scan, communication between the multifunction machine and the mail server takes a long time, which poses a problem that a user is kept waiting during this execution of the procedures. Then, if the connection between the multifunction machine and the mail server fails, a connection error occurs after the user has been kept waiting for a long time.

Further, since the multifunction machine is connected to the mail server only immediately before starting the image scan, the user cannot judge whether the setting to the mail server is correct or not before the user correctly sets the setting other than that to the mail server itself, such as the address of the electronic mail.

Further, in a multifunction machine to which a portable storage medium which stores electronic data is connectable, the same problems also occur when the multifunction machine obtains the electronic data from the portable storage medium and transmits the obtained electronic data as electronic mail.

Further, in a multifunction machine which has a facsimile receiving function and which is provided with an auxiliary memory storing facsimile data received by using this facsimile receiving function, the same problems occur when the facsimile data stored in the auxiliary memory is transmitted as electronic data.

Further, such problems can also occur in an electronic mail communication apparatus other than the multifunction machine.

### SUMMARY OF THE INVENTION

In order to accomplish the aforementioned and other objects, according to one aspect of the present invention, an electronic mail communication apparatus is connectable to a mail server and capable of transmitting electronic mail, the electronic mail communication apparatus comprises:

a connection test executing unit which conducts a detailed connection test necessary for establishing connection between the electronic mail communication apparatus and the mail server, in response to a first instruction; and

a mail transmitting unit which conducts a simple connection test between the electronic mail communication apparatus and the mail server in response to a second instruction, and thereafter transmits electronic data as the electronic mail to the mail server when the simple connection test succeeds, wherein the simple connection test is simpler than the detailed connection test.

According to another aspect of the present invention, a method of controlling an electronic mail communication apparatus which is connectable to a mail server and which is capable of transmitting electronic mail, comprises:

conducting a detailed connection test necessary for establishing connection between the electronic mail communication apparatus and the mail server, in response to a first instruction; and

conducting a simple connection test between the electronic mail communication apparatus and the mail server in response to a second instruction, and thereafter transmitting electronic data as the electronic mail to the mail server when the simple connection test succeeds, wherein the simple connection test is simpler than the detailed connection test.

### BRIEF DESCRIPTION OF THE DRAWINGS

FIG. 1 is a diagram showing an example of the network configuration of a multifunction machine system according to an embodiment of the present invention;

FIG. 2 is a block diagram showing an example of the internal configuration of a multifunction machine included in the multifunction machine system in FIG. 1;

FIG. 3 is a block diagram showing an example of the internal configuration of a mail server included in the multifunction machine system in FIG. 1;

FIG. 4 is a flowchart illustrating an example of a mail server connection test process executed in the multifunction machine according to this embodiment;

FIG. 5 is a chart showing communication between the multifunction machine and the mail server in the mail server connection test process and processing for mail transmission according to this embodiment;

FIG. 6 is a view showing an example of a function selection window displayed on a touch panel of the multifunction machine according to this embodiment;

FIG. 7 is a view showing an example of a setting mode window displayed on the touch panel of the multifunction machine according to this embodiment;

FIG. 8 is a flowchart illustrating an example of a scanned image mail transmission process executed in the multifunction machine according to this embodiment;

FIG. 9 is a view showing an example of a scan function selection window displayed on the touch panel of the multifunction machine according to this embodiment;

FIG. 10 is a view showing an example of a mail scan execution window displayed on the touch panel of the multifunction machine according to this embodiment;

FIG. 11 is a flowchart illustrating an example of an electronic data mail transmission process executed in the multifunction machine according to this embodiment;

FIG. 12 is a view showing an example of a memory function selection window displayed on the touch panel of the multifunction machine according to this embodiment;

FIG. 13 is a view showing an example of a memory-to-mail execution window displayed on the touch panel of the multifunction machine according to this embodiment; and

FIG. 14 is a view showing an example of a data list display window displayed on the touch panel of the multifunction machine according to this embodiment.

### DETAILED DESCRIPTION OF THE EMBODIMENTS

Hereinafter, an embodiment of the present invention will be described with reference to the drawings. It should be noted that the embodiment described below does not limit the construction of the claims.

In an embodiment of the present invention, a mail server connection test process is prepared in a setting mode of a multifunction machine where the setting to a mail server is made, and when a user makes the setting of the mail server, a detailed connection test between the multifunction machine and the mail server is also conducted, thereby making it possible to judge whether or not the setting for the connection therebetween is correct. Further, when the user tries to transmit image information, which is generated based on an image scanned by using a scan function, as electronic mail to the mail server, only a simple connection test between the multifunction machine and the mail server is conducted, and when receiving, from the mail server, a response to a simple command for the connection, the multifunction machine judges that the connection to the mail server can be established, and starts the scanning by the scanner function. In this manner, it is possible to reduce a user's waiting time when he/she transmits the image scanned by using the scanner function as electronic mail.

Similarly, when the user tries to transmit electronic data stored in an auxiliary memory or a portable storage medium, as electronic mail to the mail server, only a simple connection test between the multifunction machine and the mail server is conducted, and when receiving a response to a simple command for the connection from the mail server, the multifunction machine judges that the connection to the mail server can be established, and starts processing for obtaining the electronic data. In this manner, it is possible to reduce a user's waiting time when the electronic data is transmitted as electronic mail. More detailed description will be given below.

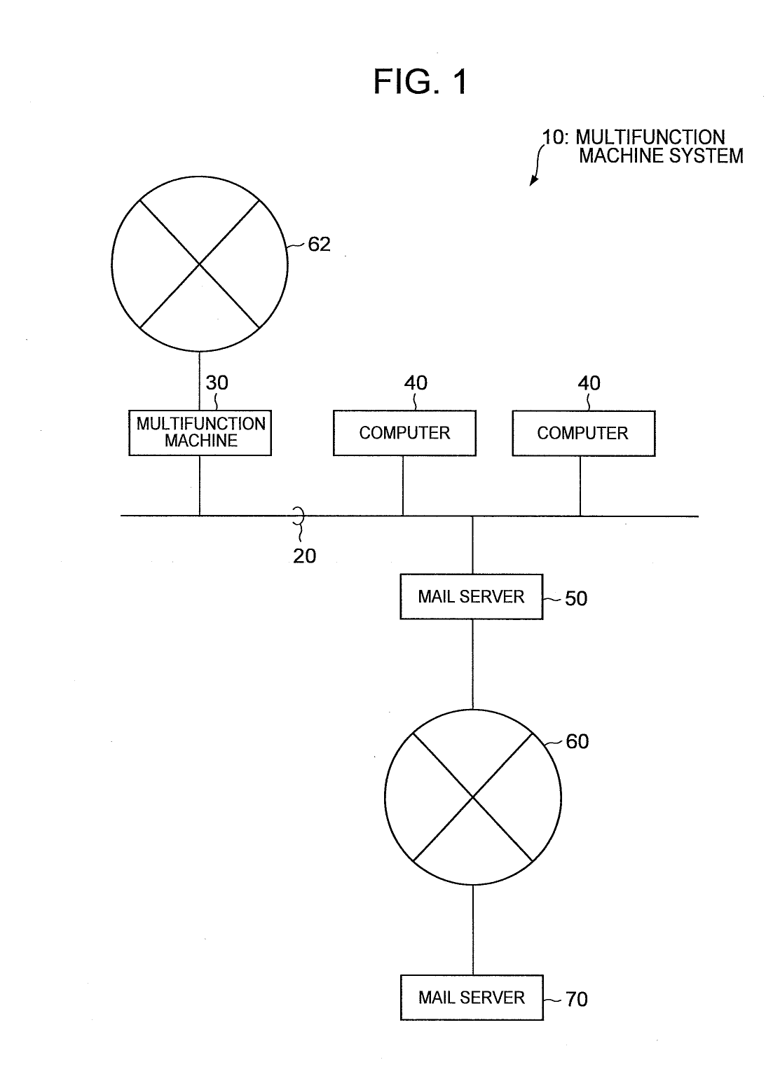

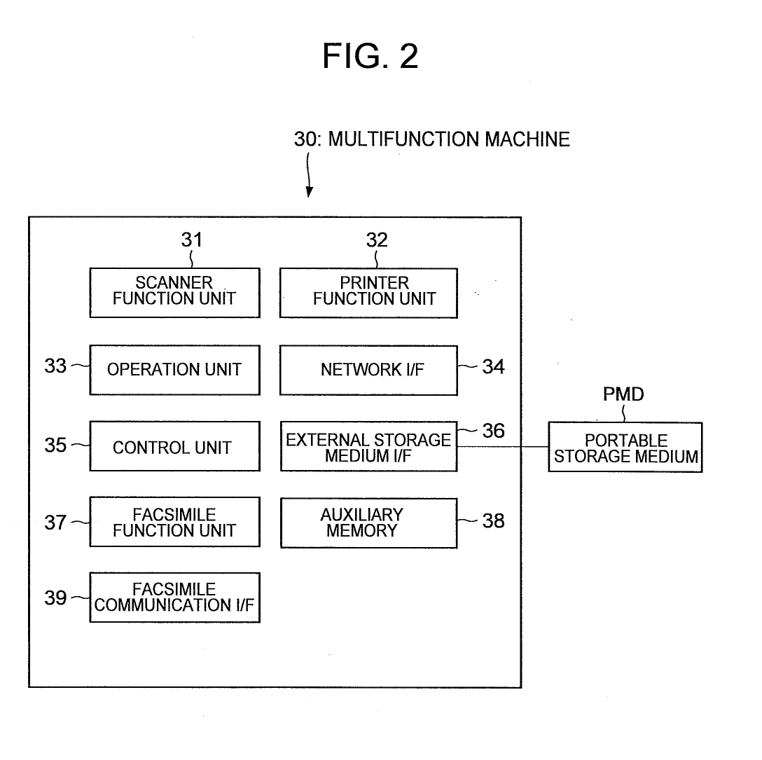

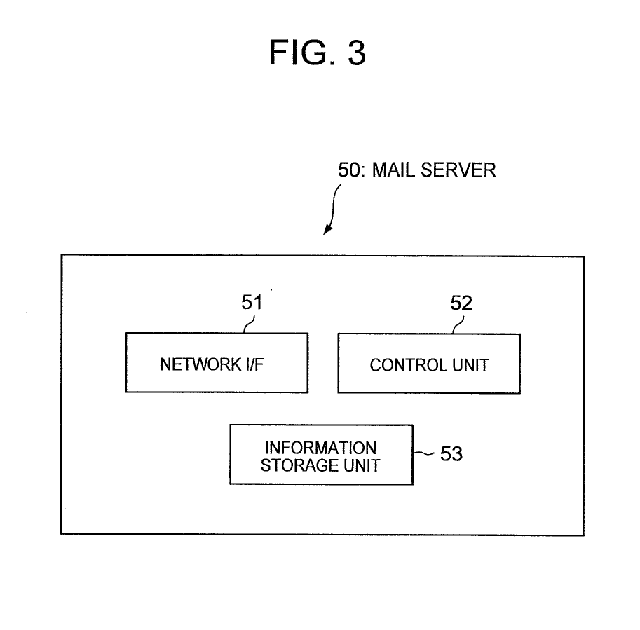

FIG. 1 shows an example of the configuration diagram of the whole multifunction machine system including a multifunction machine according to an embodiment of the present invention, FIG. 2 shows an example of a block diagram of the internal configuration of the multifunction machine according to the embodiment of the present invention, and FIG. 3 shows an example of a block diagram of the internal configuration of a mail server according to the embodiment of the present invention.

As shown in FIG. 1, a multifunction machine system 10 according to this embodiment includes one multifunction machine 30 or more, one computer 40 or more, and one mail server 50, which are mutually connected via a network. In this embodiment, the network 20 is a local network, and can be a network in an arbitrary standard such as Ethernet (registered trademark), for instance.

Further, the mail server 50 is connected to an external network 60 such as the Internet. In this embodiment, in particular, the mail server 50 receives electronic mail transmitted from the multifunction machine 20, and judges whether the received electronic mail is addressed to a mail address (mailbox) managed by itself or a mail address (mailbox) managed by any other mail server. Then, when the electronic mail is addressed not to a mail address managed by the mail server 50 but to a mail address managed by, for example, a mail server 70, the mail server 50 transmits the electronic mail to the mail server 70 via the external network 60. Incidentally, in FIG. 1, in addition to the mail server 50, another mail server may be connected to the network 20.

The multifunction machine 30 has a function of facsimile transmission and facsimile receipt via a facsimile communication network 62. Concretely, the multifunction machine 30 has a function of transmitting facsimile data to a designated destination via the facsimile communication network 62 based on an instruction from a user. The multifunction machine 30 further has a function of receiving facsimile data from another facsimile transmission apparatus connected to the facsimile communication network 62 to store and save the facsimile data or print the facsimile data.

As shown in FIG. 2, the multifunction machine 30 according to this embodiment is a so-called multifunction printer which includes at least a scanner function unit 31 and a printer function unit 32. The multifunction machine 30 further includes an operation unit 33, a network interface 34, a control unit 35, an external storage medium interface 36, a facsimile function unit 37, an auxiliary memory 38, and a facsimile communication interface 39. The scanner function unit 31 scans a document which is set on the multifunction machine 30 by a user. Generally, the scanner function unit 31 scans a document set on an document scanning surface by a line sensor and generates image information based on the scanned image.

The printer function unit 32 prints printing data transmitted from the computer 40 to the multifunction machine 30 or prints information generated based on an image scanned by the scanner function 31. Generally, it makes the printing data or the information generated based on the image into printable data, and prints the data by a print engine such as a laser printer or an inkjet printer.

The operation unit 33 is used when a user inputs various kinds of instructions to the multifunction machine 30. In this embodiment, the operation unit 33 includes, for example, a touch panel on which various kinds of information are displayed and to which a user can input the instructions by touching it.

The network interface 34 connects the multifunction machine 30 to the network 20. The control unit 35 controls the whole multifunction machine 30. In this embodiment, the control unit 35 is provided with a CPU (Central Processing Unit) which is a main control body, a RAM (Random Access Memory) which is a volatile memory storing information necessary for the control, a ROM (Read Only Memory) which is a non-volatile memory storing programs for the control, an electrically rewritable EEPROM (Electronically Erasable and Programmable ROM), and so on. In this embodiment, in particular, programs for executing a mail server connection test process, a scanned image mail transmission process, and an electronic data mail transmission process, which will be descried later, are stored in the ROM, and pieces of information necessary for executing these processes are temporarily stored in the RAM.

The external storage medium interface 36 is an interface used to connect a portable storage medium PMD to the multifunction machine 30. That is, a user can temporarily connect the portable storage medium PMD to the multifunction machine 30 via the external storage medium interface 36. The portable storage medium PMD is an example of an external storage medium of the multifunction machine 30, and typical examples thereof are a USB memory, a memory card, a flexible disk, and the like. Further, the external storage medium interface 36 is an example of a connection function unit for enabling the portable storage medium PMD as the external storage medium to be connected to the multifunction machine 30, and it is compliant with the specification adapted to the kind of the connected portable storage medium PMD.

In this embodiment, for example, by operating the operation unit 33, a user can read electronic data stored in the portable storage medium PMD and have the printer function unit 32 execute printing based on the electronic data. Further, by operating the operation unit 33, a user can read electronic data stored in the portable storage medium PMD and transmit the electronic data as electronic mail via the mail server 50.

The facsimile function unit 37 executes various controls for realizing the facsimile function in the multifunction machine 30. Specifically, the multifunction machine 30 is connected to the aforesaid facsimile communication network 62 via the facsimile communication interface 39. Therefore, the facsimile function unit 37 realizes the facsimile receiving function by receiving facsimile data from the facsimile communication network 62 via the facsimile communication interface 39 and having the facsimile data printed by the printer function unit 32. Further, the facsimile function unit 37 realizes the facsimile receiving function also by receiving facsimile data from the facsimile communication network 62 via the facsimile communication interface 39 and having the facsimile data stored as electronic data in the auxiliary memory 38. In this embodiment, the auxiliary memory 38 is, for example, a mass storage device such as a hard disk drive. Therefore, even electronic data with large data size can be stored in large quantity in the auxiliary memory 38.

The facsimile function unit 37 further realizes the facsimile transmitting function by converting information, which is generated based on an image scanned by the scanner function unit 31, into facsimile data and transmitting the facsimile data to the facsimile communication network 62 based on an instruction from a user. A destination of the transmission using the facsimile transmitting function, that is, the fax number is designated by a user operating the operation unit 33.

Further, in this embodiment, electronic data that the facsimile function unit 37 has stored in the auxiliary memory 38 can be transmitted as electronic mail. Specifically, by operating the operation unit 33, a user can read the electronic data stored in the auxiliary memory 38 and transmit the electronic data as electronic mail via the mail server 50. Details of a concrete user's operation and the processing contents in the multifunction machine 30 at this time will be described later.

As shown in FIG. 3, the mail server 50 includes at least a network interface 51, a control unit 52, and an information storage unit 53. The network interface 51 connects the mail server 50 to the network 20 and the external network 60. The control unit 52 controls the whole mail server 50. In this embodiment, the control unit 52 is provided with a CPU (Central Processing Unit) as a main control body, a RAM (Random Access Memory) which is a volatile memory storing information necessary for the control, and a ROM (Read Only Memory) which is a non-volatile memory storing programs for the control.

The information storage unit 53 is a unit where authentication information of users managed by the mail server 50, destinations represented by electronic mail addresses managed by the mail server 50, electronic mail stored in mailboxes managed by the mail server 50, and so on are stored and held. In this embodiment, the information storage unit 53 is, for example, an auxiliary memory such as a hard disk drive.

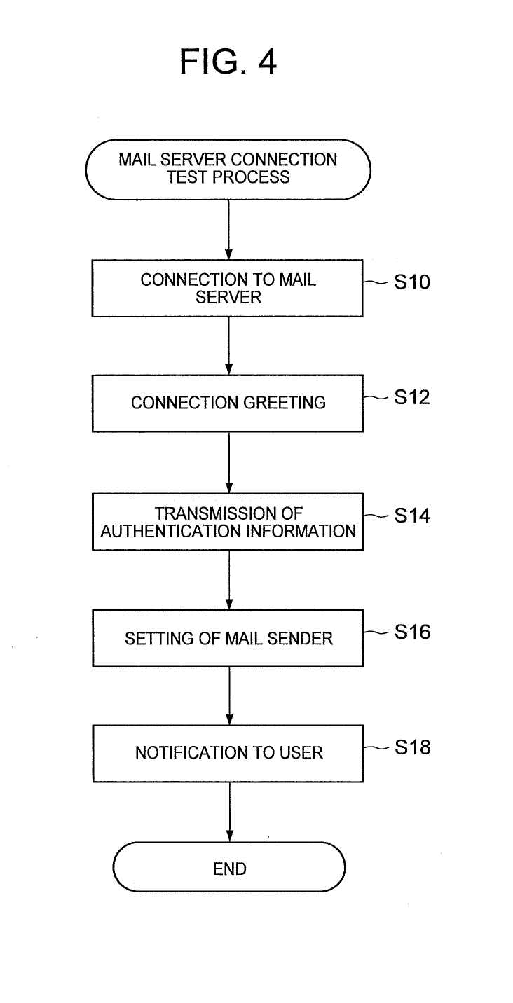

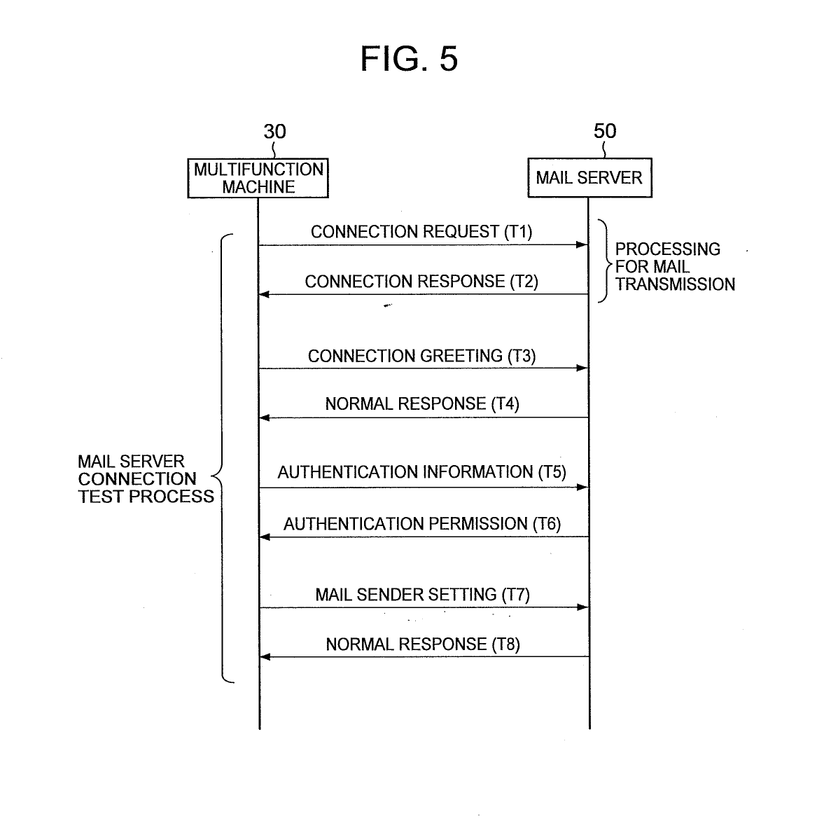

Next, the mail server connection test process executed in the multifunction machine 30 according to this embodiment will be described based on FIG. 4 and FIG. 5. FIG. 4 is a flowchart illustrating the contents of the mail server connection test process according to this embodiment, and FIG. 5 is a chart illustrating an example of a communication protocol between the multifunction machine 30 and the mail server 50 in the mail server connection test process.

The mail server connection test process shown in FIG. 4 is executed by the control unit 35 in the multifunction machine 30, and more concretely, this process is realized by the CPU, which is provided in the control unit 35, reading a mail server connection test process program from the ROM, which is also provided in the control unit 35, and executing this program.

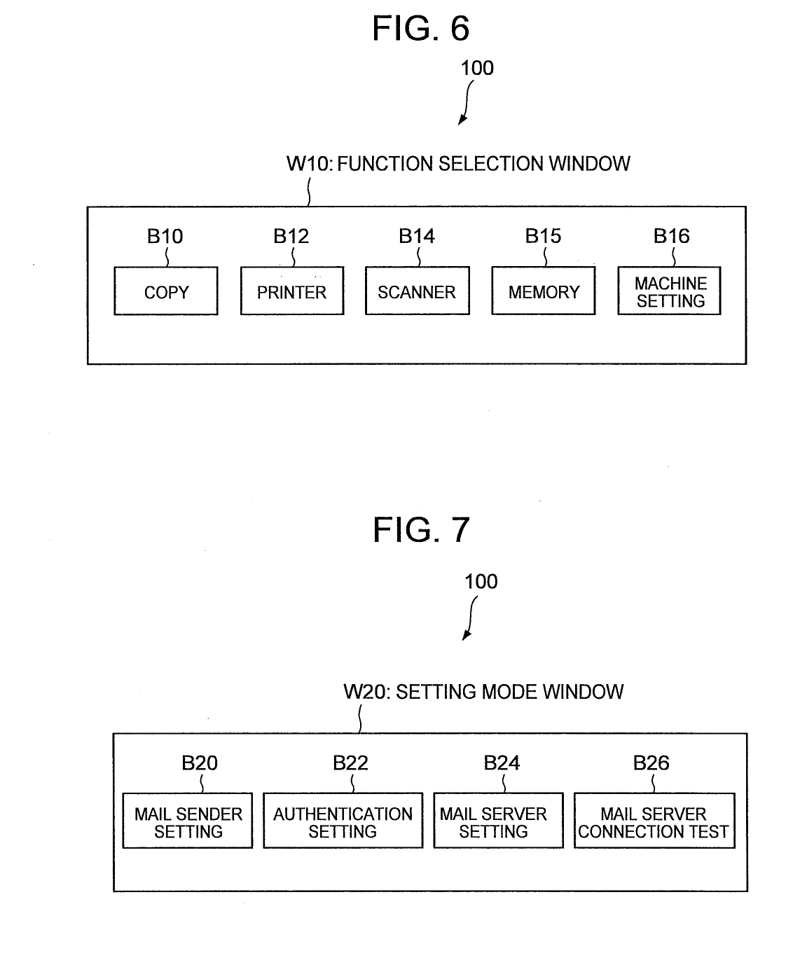

The mail server connection test process is activated when a user sets the multifunction machine 30 to a setting mode and inputs to the multifunction machine 30 an instruction for starting a process where a detailed connection test necessary for establishing the connection between the multifunction machine 30 and the mail server is conducted. For example, it is assumed that a function selection window W10 as a main menu is displayed on a touch panel 100 of the operation unit 33 as shown in FIG. 6. In the example in FIG. 6, a copy function select button B10, a printer function select button B12, a scanner function select button B14, a memory data obtaining function select button B15, and a machine setting button B16 are displayed on the function selection window W10.

When the user touches the copy function select button B10 in this state, the multifunction machine 30 enters a copy mode, and when the user touches the printer function select button B12, the multifunction machine 30 enters a mode where printing data received from the computer 40 is printed. When the user touches the scanner function select button B14 on the function selection window W10, the multifunction machine 30 enters a mode where the scanner function unit 31 is used, and when the user touches the memory data obtaining function select button B15, the multifunction machine 30 enters a mode where electronic data stored in the portable storage medium PMD or the auxiliary memory 38 is transmitted as electronic mail.

On the other hand, when the user touches the machine setting button B16, the multifunction machine 30 enters the setting mode where various kinds of settings of the multifunction machine 30 are made, and displays a setting mode window W20 shown in FIG. 7 on the touch panel 100 of the operation unit 30.

In the example in FIG. 7, a mail sender setting button B20, an authentication setting button B22, a mail server setting button 24, and a mail server connection test button 26 are displayed on the setting mode window W20. When the user touches the mail sender setting button B20 in this state, the multifunction machine 30 enters a mail sender setting mode, where the user can set his/her own mail address. When the user touches the authentication setting button B22, the multifunction machine 30 enters an authentication setting mode, where the user can set his/her own authentication information (user ID, a password, and the like). When the user touches the mail server setting button B24, the multifunction machine 30 enters a mail server setting mode, where the user can set IP address, the port number, and the like of the mail server. These pieces of information set in these modes are stored and held in the aforesaid EEPROM of the control unit 35. On the other hand, when the user touches the mail server connection test button 26, the mail server connection test process in FIG. 4 is activated.

As shown in FIG. 4, when the mail server connection test process is started, the multifunction machine 30 establishes the connection to the mail server 50 (Step S10). An example where SMTP (Simple Mail Transfer Protocol) is used as the communication protocol will be described. In this case, the multifunction machine 30 is a sender SMTP client and the mail server 50 is a recipient SMTP server.

The processing at Step S10 corresponds to connection request T1 and connection response T2 which is a response to the connection request T1, in FIG. 5. When transmitting the connection request T1 to the mail server 50, the multifunction machine 30 uses, for example, TCP port number 25. The TCP port number used for the connection request T1 can be arbitrarily set in the mail server 50 in some case, and when the TCP port number is set in the mail server 50, the multifunction machine 30 transmits the connection request T1 by using the predetermined TCP port number that is set. However, when the TCP port number cannot be set in the mail server 50 or when such setting is not made therein, the multifunction machine 30 transmits the connection request T1 by using the TCP port number 25. Setting information necessary for the connection request T1 is input to the multifunction machine 30 in the mode entered when the aforesaid mail server setting button B24 is touched. The mail server 50 receiving the connection request T1 transmits the connection response T2 indicating the normal acceptance of the connection request T1, to the multifunction machine 30 by return.

Next, as shown in FIG. 4, the multifunction machine 30 sends a connection greeting to the mail server 50 according to the SMTP protocol (Step S12). The processing at Step S12 corresponds to connection greeting T3 and normal response T4 which is a response to the connection greeting T3, in FIG. 5. In the connection greeting T3, the multifunction machine 30 transmits its own host name to the mail server 50 by using a HELO command. The mail server 50 receiving the connection greeting T3 transmits the normal response T4 indicating the normal acceptance of the connection greeting T3 by return to the multifunction machine 30.

Next, as shown in FIG. 4, the multifunction machine 30 transmits the authentication information to the mail server 50 (Step S14). The processing at Step S14 corresponds to authentication information T5 and authentication permission T6 which is a response to the authentication information T5, in FIG. 5. In the transmission of the authentication information T5, the multifunction machine 30 transmits the user ID and password to the mail server 50. Information necessary for the transmission of the authentication information T5 is input to the multifunction machine 30 in the mode entered when the aforesaid authentication setting button B22 is touched. The mail server 50 receiving the authentication information T5 judges whether or not the received user ID and password match a registration user ID and a registration password which are registered in advance.

Concretely, the mail server 50 judges whether or not the user ID included in the received authentication information T5 is present among the registration user IDs stored in the information storage unit 53, and when the received user ID is present therein, it also judges whether or not the password included in the received authentication information T5 matches a registration password which is stored in the information storage unit 53 in correspondence to the registration user ID. When these received user ID and password match the registration user ID and the registration password which are registered in advance in the information storage unit 53, the mail server 50 transmits the authentication permission T6 by return to the multifunction machine 30. When the received user ID and password match none of the registration user IDs and the registration passwords registered in advance in the information storage unit 53, the mail server 50 transmits authentication rejection by return to the multifunction machine 30, so that the mail server connection test process turns out to be a failure.

Incidentally, the transmission of the authentication information at Step S14 can be omitted when the mail server 50 does not demand for the authentication processing of the multifunction machine 30.

Next, as shown in FIG. 4, the multifunction machine 30 sends the setting of the mail sender to the mail server 50 (Step S16). The processing at Step S16 corresponds to mail sender setting T7 and normal response T8 which is a response to the mail sender setting T7, in FIG. 5. In the transmission of the mail sender setting T7, the multifunction machine 30 transmits a mail address of the transmitting end (that is, an electronic mail address of this user) to the mail server 50 by using a mail command. The mail address of the transmitting end is input to the multifunction machine 30 in the mode entered when the aforesaid mail sender setting button B20 is touched. The mail server 50 receiving the mail sender setting T7 checks the format of the received mail address of the transmitting end and thereafter stores it in the information storage unit 53 and transmits the normal response T8 indicating the normal receipt of the mail address of the transmitting end, by return to the multifunction machine 30.

Next, as shown in FIG. 4, the multifunction machine 30 notifies the user of the result of the mail server connection test (Step S18). Specifically, when the processing from Step S10 to Step S16 is normally executed and the connection between the multifunction machine 30 and the mail server 50 is established, the multifunction machine 30 notifies the user of a success in the connection test. On the other hand, when the connection between the multifunction machine 30 and the mail server 50 cannot be established due to some error occurring in the course of Step S10 to Step S16, the multifunction machine 30 notifies the user of a failure in the connection test. At this time, the reason for the occurrence of the error, such as, for example, the error in the authentication at Step S14 can be appended to the notification to the user.

For such notification, the notification contents may be displayed on the touch panel 100, for instance. However, when information to be notified to the user cannot be displayed on the touch panel 100 because its volume is large, the notification contents may be printed by the printer function unit 32 for this notification to the user.

Here, the mail server connection test process according to this embodiment is finished.

### <Scanned Image Mail Transmission Process>

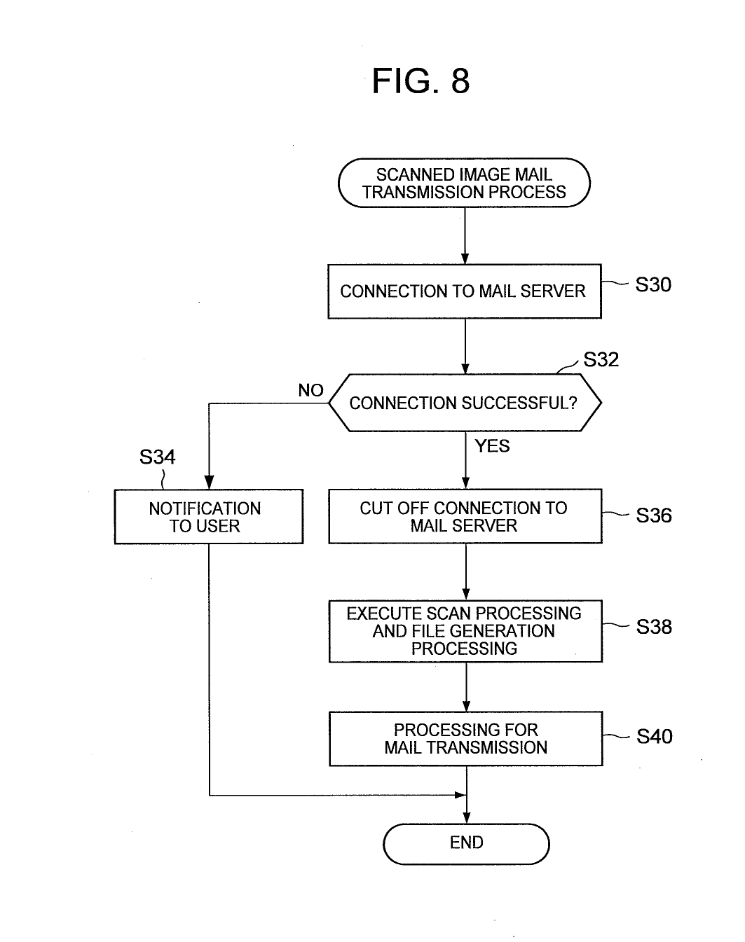

Next, a scanned image mail transmission process executed in the multifunction machine 30 according to this embodiment will be described based on FIG. 8. FIG. 8 is a flowchart illustrating the contents of the scanned image mail transmission process according to this embodiment.

The mail transmission process shown in FIG. 8 is executed by the control unit 35 in the multifunction machine 30, and more concretely, this process is realized by the CPU, which is provided in the control unit 35, reading a mail transmission process program from the ROM, which is also provided in the control unit 35, and executing the read program.

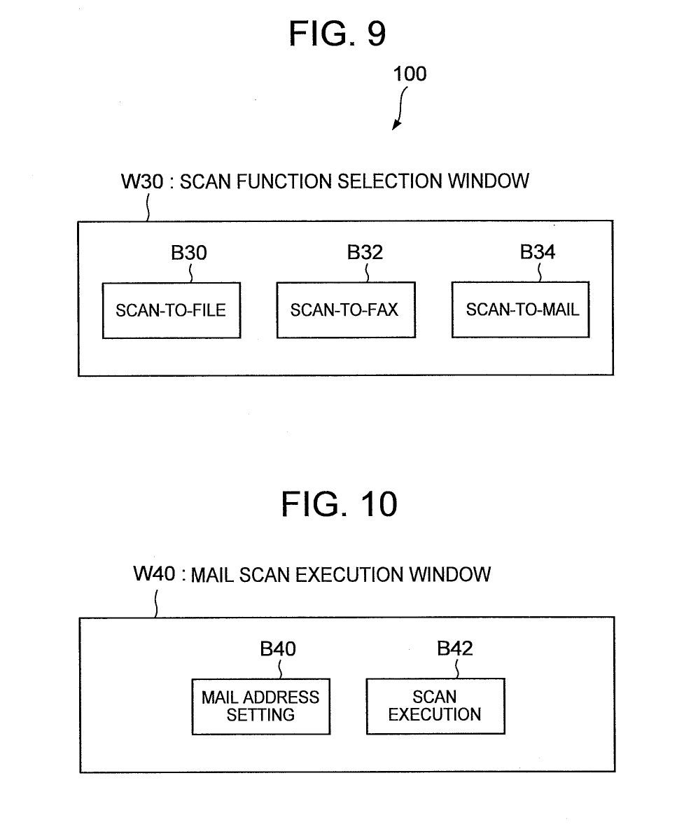

The mail transmission process is activated when a user sets the multifunction machine 30 to a mail-to-scan mode and inputs to the multifunction machine 30 an instruction for starting the scan of a document. For example, when the user touches the scanner button B14 on the aforesaid function selection window W10 in FIG. 6, a scan function selection window W30 shown in FIG. 9 is displayed on the touch panel 100.

In the example in FIG. 9, a scan-to-file button B30, a scan-to-fax button B32, and a scan-to-mail button B34 are displayed on the scan function selection window W30. When the user touches the scan-to-file button B30 on the scan function selection window W30, the multifunction machine 30 enters a mode where image information generated by scanning by the scanner function unit 31 is transferred to and stored in a save destination folder designated by the user. Further, when the user touches the scan-to-fax button B32 on the scan function selection window W30, the multifunction machine 30 enters a mode where image information generated by scanning by the scanner function unit 31 is facsimiled to the fax destination number designated by the user.

When the user touches the scan-to-mail button B34 on the scan function selection window W30, the multifunction machine 30 enters a mode where image information generated by scanning by the scanner function unit 31 is transmitted to an electronic mail address designated by the user. In this embodiment, when the user touches the scan-to-mail button B34, a mail scan execution window W40 shown in FIG. 10 is displayed on the touch panel 100.

When the user touches a mail address setting button B40 on the mail scan execution window W40, the multifunction machine 30 enters a mode where the user designates an address to which image information generated based on an image scanned by using the scanner function unit 31 is to be transmitted as electronic mail. On the other hand, when the user touches a scan execution button B42 after setting a document on an auto document feeder (ADF), the mail transmission process in FIG. 8 is activated.

As shown in FIG. 8, when the mail transmission process is started, the multifunction machine 30 establishes connection to the mail server 50 (Step S30). The processing at Step S30 corresponds to the connection request T1 and the connection response T2 which is a response to the connection request T1, in FIG. 5. As described above, in the connection request T1, the multifunction machine 30 transmits the connection request T1 to the mail server 50 by using, for example, the TCP port number 25. Alternatively, when the TCP port number is set in the mail server 50, the multifunction machine 30 transmits the connection request T1 by using the predetermined TCP port number that is set. The mail server 50 receiving the connection request T1 transmits the connection response T2 indicating the acceptance of the connection request T1 by return to the multifunction machine 30.

Next, as shown in FIG. 8, the multifunction machine 30 judges whether or not the connection to the mail server 50 has succeeded (Step S32). Concretely, when receiving, from the mail server 50, the connection response T2 indicating the normal acceptance of the connection request T1, the multifunction machine 30 judges that the connection to the mail server 50 has succeeded. On the other hand, when the connection response T2 cannot be received within a predetermined time, the multifunction machine 30 judges that the connection to the mail server 50 has failed. When the connection to the mail server 50 has failed (Step S32: NO), the multifunction machine 30 notifies the user of the failure in the connection to the mail server 50 (Step S34). For this notification, for example, a message to the effect that the connection has failed may be displayed on the aforesaid touch panel 100, or a message to the effect that the connection has failed may be printed by the printer function unit 32. Then, this mail transmission process is finished.

On the other hand, when the connection to the mail server 50 has succeeded (Step S32: YES), the multifunction machine 30 cuts off the connection to the mail server 50 (Step S36).

Next, the multifunction machine 30 executes scan processing and file generation processing (Step S38). Specifically, the scanner function unit 31 scans a document that the user sets on the automatic document feeder and its image is made into a file in a Tiff format or the like.

Then, after scanning all the documents set on the automatic document feeder, the multifunction machine 30 performs processing for transmitting the image information in the form of a file, as electronic mail to the mail server 50. As described above, a destination to which the electronic mail is to be transmitted is a mail address that the user has set in the mode entered when the mail address setting button B40 is touched. When this processing for the mail transmission is completed, the mail transmission process is finished.

### <Electronic Data Mail Transmission Process>

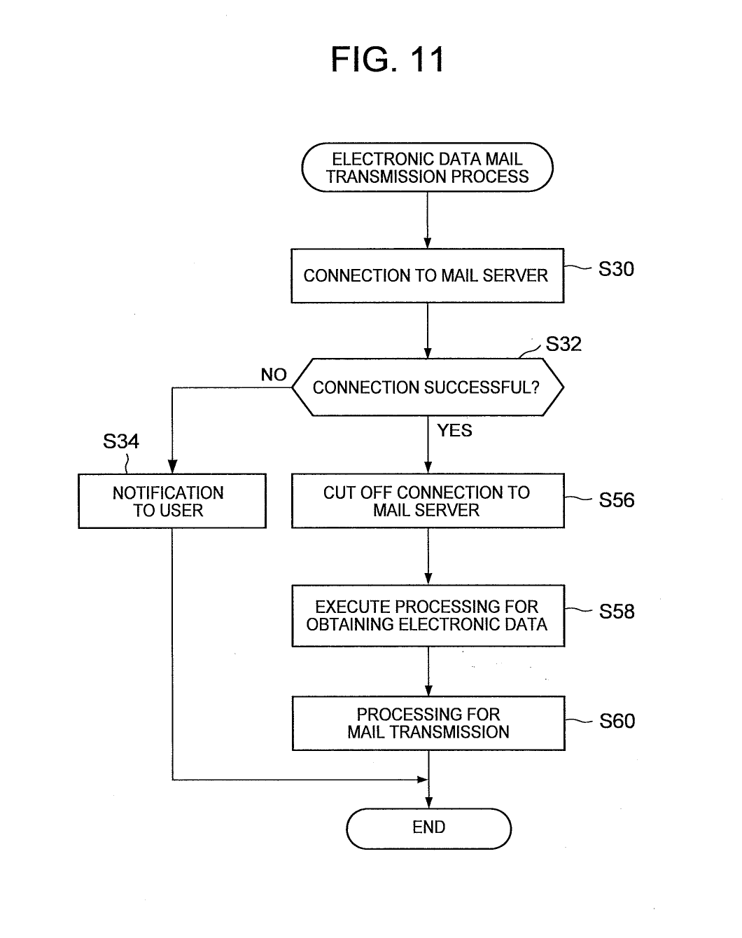

Next, an electronic data mail transmission process executed in the multifunction machine 30 will be described based on FIG. 11. FIG. 11 is a flowchart illustrating the contents of the electronic data mail transmission process according to this embodiment.

In the scanned image mail transmission process described with reference to FIG. 8, after judging that the connection to the mail server 50 has succeeded (Step S32: YES) and cutting off the connection to the mail server 50, the multifunction machine 30 executes the scan processing and the file generation processing, but in this electronic data mail transmission process, the multifunction machine 30 obtains electronic data designated by a user and performs processing for mail transmission. In other respects, the electronic data mail transmission process is the same as the above-described scanned image mail transmission process.

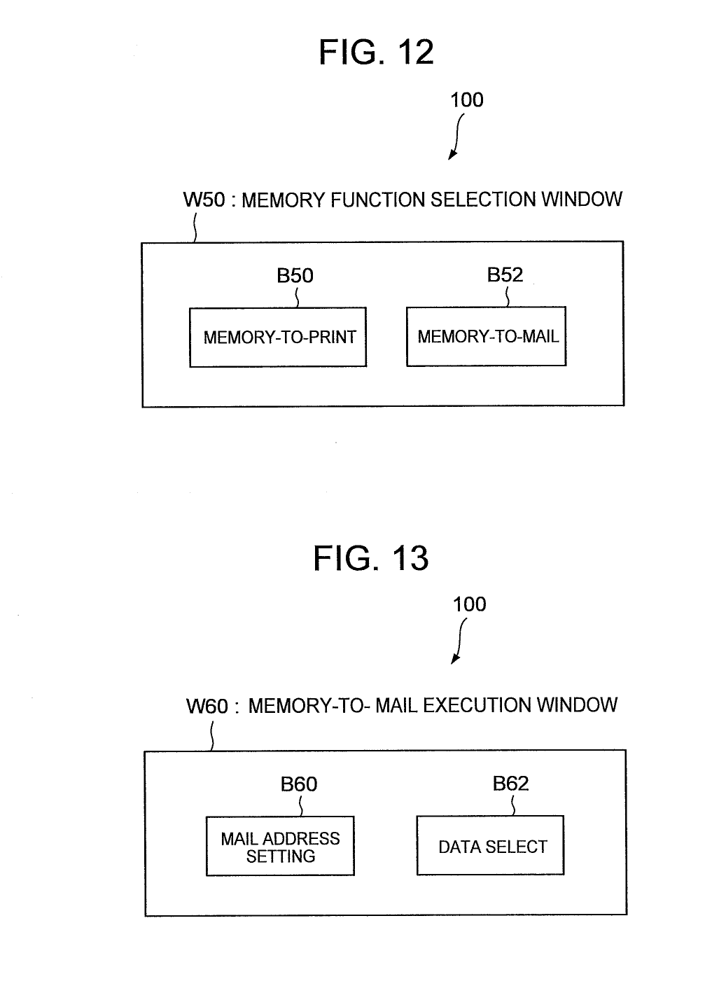

The electronic data mail transmission process in FIG. 11 is activated when the user sets the multifunction machine 30 to an electronic data transmission mode, designates electronic data to be transmitted, and instructs the mail transmission. For example, when the user touches the memory data obtaining function select button B15 on the aforesaid function selection window W10 in FIG. 6, a memory function selection window W50 shown in FIG. 12 is displayed on the touch panel 100.

In this embodiment, a memory-to-print button B50 and a memory-to-mail button B52 are displayed on the memory function selection window W50. After touching the memory-to-print button B50 on the memory function selection window W50, the user can designate electronic data to be printed by a subsequent operation, so that the electronic data can be printed by the printer function unit 32. The electronic data to be printed is stored in, for example, the portable storage medium PMD or is stored in the auxiliary memory 38.

After touching the memory-to-mail button B52 on the memory function selection window W50, the user can transmit electronic data that he/she designates by a subsequent operation, as electronic mail. In this embodiment, when the user touches the memory-to-mail button B52, a memory-to-mail execution window W60 shown in FIG. 13 is displayed on the touch panel 100.

When the user touches a mail address setting button B60 on the memory-to-mail execution window W60, the multifunction machine 30 enters a mode where a destination to which the electronic data is to be transmitted as electronic mail is designated. Specifically, when the user touches the mail address setting button B60, the multifunction machine 30 enters the mode where the electronic mail address of the transmission destination is designated.

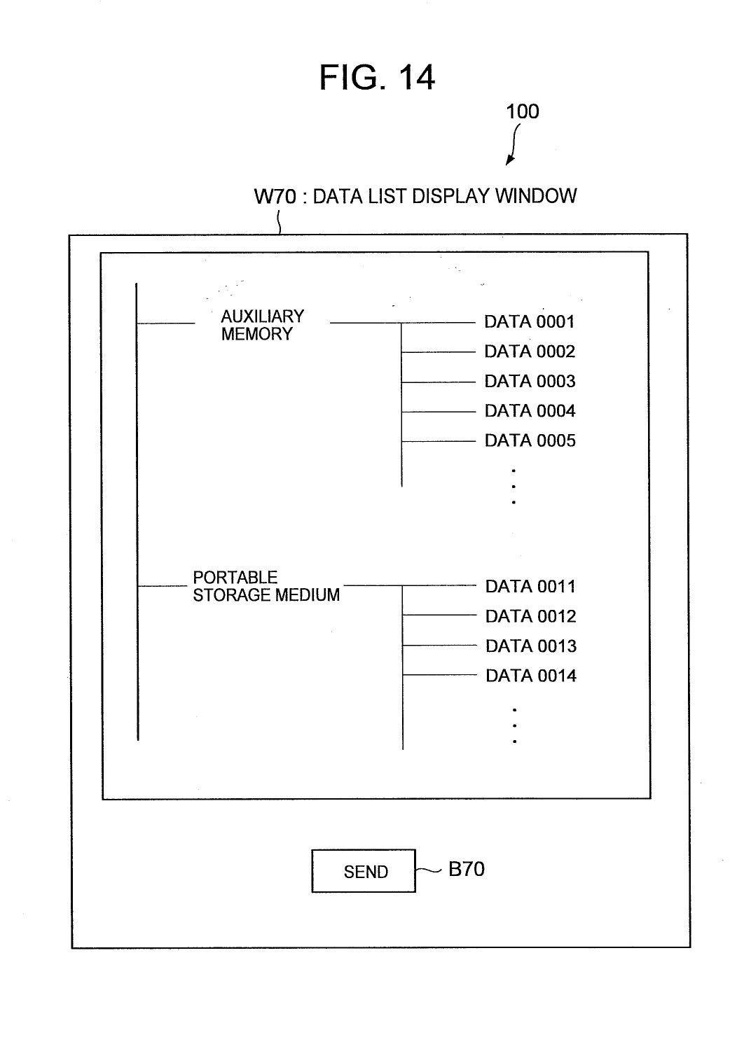

On the other hand, when the user touches a data select button B62, a data list display window W70 shown in FIG. 14 is displayed on the touch panel 100. As shown in FIG. 14, a list of electronic data stored in the auxiliary memory 38 is displayed on the data list display window W70. When the portable storage medium PMD is connected to the multifunction machine 30, a list of electronic data stored in the portable storage medium PMD is also displayed on the data list display window W70. How the electronic data to be transmitted is selected from the displayed electronic data may be any, and for example, for the selection, the file name of the electronic data displayed on the touch panel 100 may be touched, or an arrow key or a selection key, not shown, provided on the operation unit 33 may be used. Further, the file name of the already selected electronic data may be highlighted.

A send button B70 is further provided on the data display list window W70, and when the user touches the send button B70 after selecting one electronic data or more to be transmitted, the electronic data mail transmission process in FIG. 11 is activated.

In the electronic data mail transmission process shown in FIG. 11, processing for connection between the multifunction machine 30 and the mail server 50 (Step S30) and processing when the connection is judged as a failure (Step S34) are the same as those of the above-described scanned image mail transmission process in FIG. 8. Here, only other different points will be described.

When the connection to the mail server 50 succeeds at Step S32 (Step S32: YES), the multifunction machine 30 cuts off the connection to the mail server 50 (Step S56).

Next, the multifunction machine 30 executes processing for obtaining electronic data of a file selected by the user (Step S58). For example, when the user has designated electronic data stored in the portable storage medium PMD, the multifunction machine 30 obtains, from the portable storage medium PMD, the electronic data designated by the user. When the user has designated electronic data stored in the auxiliary memory 38, the multifunction machine 30 obtains the electronic data stored in the auxiliary memory 38. Incidentally, when the user has designated a plurality of electronic data, the plural electronic data are obtained.

Next, the multifunction machine 30 executes processing for transmitting the electronic data obtained at Step S58, as electronic mail to the mail server 50 (Step S60). As described above, a destination to which the electronic mail is to be transmitted is an electronic mail address set by the user in the mode entered when the mail address setting button B60 is touched. When this processing for mail transmission at Step S60 is completed, the mail transmission process is finished.

As described above, according to the multifunction machine 30 of the multifunction machine system according to this embodiment, it is possible to conduct the detailed connection test between the multifunction machine 30 and the mail server 50 by the mail server connection test process. In particular, the mail server connection test process can be executed even before the information such as the transmission destination of the electronic mail is input, providing that this mail server connection test process comes after the user inputs the information necessary for the connection to the mail server, such as the IP address of the mail server and the setting of the mail sender. Therefore, it is possible to conduct the connection test between the multifunction machine 30 and the mail server 50 by executing the mail server connection process, without the user's input of the information such as the transmission destination of the electronic mail.

Further, since the connection test for the connection to the mail server 50 has been completed when the user tries to transmit electronic mail, it is possible to start the scan processing (Step S38) using the scanner function unit 31 or the electronic data obtaining processing (Step S58), only by conducting, at Step S30 in the mail transmission process, a simple connection test to check whether or not the connection to the mail server 50 is possible. Specifically, in the explanatory chart of the communication protocol in FIG. 5, when receiving the connection response T2, which is a response to the connection request T1, from the mail server 50, the multifunction machine 30 judges that the connection to the mail server 50 can be normally established and can execute the scan processing, without executing the subsequent processing for establishing the connection. Therefore, it is possible to reduce the waiting time until the scanning is started after the user touches the scan execution button B42. Further, it is possible to reduce the waiting time until the electronic data is obtained after the user designates the electronic data to be transmitted and touches the transmission button B70.

It should be noted that the present invention is not limited to the above-described embodiment, but can be variously modified. For example, the above embodiment describes the example where the present invention is applied to the multifunction machine 30 as an example of an electronic mail communication apparatus, but the present invention is applicable to other kinds of electronic mail communication apparatuses.

Further, in the above embodiment, the present invention is described, taking as an example, the case where the communication protocol between the multifunction machine 30 and the mail server 50 is SMTP, but the present invention is also applicable to the case where another communication protocol is used.

Further, as for the mail server connection test process, the scanned image mail transmission process, and the electronic data mail transmission process, programs for executing these processes may be distributed in the form of a recording medium, by being recorded in a recording medium such as a flexible disk, a CD-ROM (Compact Disc Read. Only Memory), a ROM, or a memory card. In this case, it is possible to realize the above-described embodiment by the multifunction machine 30 reading the programs recorded in this recording medium and executing the read programs.

Further, the above embodiment describes the example where the mail server connection test process, the scanned image mail transmission process, and the electronic data mail transmission process are realized by software, but these processes may be realized by hardware such as ASIC (Application Specific IC). Alternatively, these processes may be realized by the cooperation of software and hardware.

What is claimed is:

1. An electronic mail communication apparatus which is connectable to a mail server and which is capable of transmitting electronic mail, the electronic mail communication apparatus comprising:
a connection test executing unit which conducts a detailed connection test necessary for establishing connection between the electronic mail communication apparatus and the mail server, in response to a first instruction; and
a mail transmitting unit which conducts a simple connection test between the electronic mail communication apparatus and the mail server in response to a second instruction, and thereafter transmits electronic data as the electronic mail to the mail server when the simple connection test succeeds, wherein the simple connection test is simpler than the detailed connection test.

2. The electronic mail communication apparatus according to claim 1, wherein the mail transmitting unit does not transmit the electronic data as the electronic mail when the simple connection test does not succeed.

3. The electronic mail communication apparatus according to claim 1, wherein a user inputs the first instruction when the user makes setting for connection between the electronic mail communication apparatus and the mail server.

4. The electronic mail communication apparatus according to claim 1, wherein the second instruction input is an instruction regarding the transmission of the electronic data as the electronic mail.

5. The electronic mail communication apparatus according to claim 1, wherein the mail transmitting unit comprises a scanner function unit, and the electronic data is image data as an image scanned in the scanner function unit.

6. The electronic mail communication apparatus according to claim 5, wherein the mail transmitting unit does not execute scanning operation by the scanner function unit when the simple connection test does not succeed.

7. The electronic mail communication apparatus according to claim 1, further comprising:
a connection function unit to which an external storage medium is connectable; and
an electronic data obtaining unit which obtains electronic data stored in the external storage medium connected the connection function unit, and
wherein the electronic data is electronic data obtained by the electronic data obtaining unit.

8. The electronic mail communication apparatus according to claim 7, wherein the mail transmitting unit does not obtain the electronic data by the electronic data obtaining unit when the simple connection test does not succeed.

9. The electronic mail communication apparatus according to claim 1, further comprising:
a facsimile receiving function unit which receives facsimile data;
a facsimile data storage unit in which the facsimile data received by the facsimile receiving function unit is stored, as electronic data; and
a facsimile data obtaining unit which obtains the facsimile data stored in the facsimile data storage unit, and
wherein the electronic data transmitted by the mail transmitting unit is the facsimile data obtained by the facsimile data obtaining unit.

10. The electronic mail communication apparatus according to claim 9, wherein the mail transmitting unit does not obtain the facsimile data by the facsimile data obtaining unit when the simple connection test does not succeed.

11. The electronic mail communication apparatus according to claim 1, wherein the mail transmitting unit executes the simple connection test by transmitting a connection request using a predetermined TCP port number.

12. The electronic mail communication apparatus according to claim 11, wherein the connection test executing unit executes at least connection request using the predetermined TCP port number, connection confirmation using a HELO command, and sender setting using a mail command, in the detailed connection test.

13. The electronic mail communication apparatus according to claim 12, wherein the connection test executing unit further executes transmission of authentication information in the detailed connection test.

14. A method of controlling an electronic mail communication apparatus which is connectable to a mail server and which is capable of transmitting electronic mail, the method comprising:
conducting a detailed connection test necessary for establishing connection between the electronic mail communication apparatus and the mail server, in response to a first instruction; and
conducting a simple connection test between the electronic mail communication apparatus and the mail server in response to a second instruction, and thereafter transmitting electronic data as the electronic mail to the mail server when the simple connection test succeeds, wherein the simple connection test is simpler than the detailed connection test.
